(19) United States
(12) Patent Application Publication
(10) Pub. No.: US 2023/0139715 A1
(43) Pub. Date: May 4, 2023

(54) Reinforcing of Solid Round Legs in Telecom Towers

(71) Applicant: Ashraf Radi, Kitchener (CA)

(72) Inventor: Ashraf Radi, Kitchener (CA)

(21) Appl. No.: 16/974,379

(22) Filed: May 22, 2021

(51) Int. Cl. E04H 12/22

(52) U.S. Cl. CPC E04H 12/2292; E04H 2012/006

(57) ABSTRACT

A method of reinforcing the solid round leg in existing telecom towers (Guyed & Self-Support), it increases the leg resistance in compression (bearing load) over 50%. This type of reinforcing uses the principal and definition of axial force in truss structure by keeping the center of gravity of the new reinforcing members in the same location of the existing solid round leg. This type of reinforcing uses the existing splice pads as a foundation and a platform to build the new reinforcing structure on it. The new reinforcing structure is a replacement of the existing bolting system with new threaded bars and couplers with high strength. The addition of the new threaded bars benefits the overstressed leg, by adding more cross-sectional area to the original solid round leg section.

### TECHNICAL FIELD

Structural Analysis and Reinforcing of Existing Telecom Towers with Solid Round Legs.

### BACKGROUND OF THE INVENTION

The telecom business is in action every day due to the fast-growing technologies and the country needs. Telecom companies have so many towers that were built in the country and it was not designed for current time requirements, even new towers sometimes the client does not provide accurate antenna loading due to the lack of information about the future or no clear prediction of what new technology could be or would need. So, most of the towers fail in the structural analysis, and require extraordinarily strong reinforcing to keep it alive.

Leg Reinforcing in telecom towers have long been known and widely used when the legs become overstressed, and loads are more than its capacity. Engineers used to weld additional bars beside the solid round legs to increase the cross-sectional area to avoid any overstressing issues in legs. Later they used to add additional bars using U-bolts. Using U-bolt is a new way of adding bars to avoid welding on site. Both types are adding bars direct to the leg (welded or U-bolted).

### SUMMARY OF THE INVENTION

Solid round leg comes with splice plates (flange plates) at top and bottom and bolts to connect. In this invention, reinforcing is using top and bottom splices, replacing existing bolts with threaded bars, nuts, and washers, then adding threaded bars, lock nuts & couplers, mounted to the threaded bars top & bottom. Tightening couplers will split the loads between solid round leg & threaded bars.

### BRIEF DESCRIPTION OF THE DRAWINGS

FIG. 1 is a profile of a guyed tower.

FIG. 2 is a profile of a self-support tower.

FIG. 3 is an isometric of a solid round section, showing top splice (TS), bottom splice (BS), Bracing (BR) & leg (LG).

FIG. 4 is an isometric of an extracted solid round leg with splice pads, top & bottom. Section s-s, showing cross section in solid round leg.

FIG. 5 is an assembly of three solid round sections without reinforcing, showing existing bolting system (2)& solid round leg (1)

FIG. 6 is an isometric of an extracted solid round leg (1) showing details of existing bolting system (bolt 2.1, washer 2.2 & nut 2.3)

FIG. 7 is an isometric of an extracted solid round leg (1) showing replacement of an existing bolt with a new threaded bar top (I) & bottom (II) and intermediate assembly (III) on the side.

FIG. 7A is an isometric of an extracted solid round leg (1) showing replacement of an existing bolt with a new threaded bar top (I) & bottom (II) and intermediate assembly (III).

FIG. 8 are an isometric & 2D views of an enlarged detail of assembly (I)

FIG. 9 are an isometric & 2D views of an enlarged detail of assembly (II)

FIG. 10 are an isometric & 2D views of an enlarged detail of assembly (III)

FIG. 11 is an elevation of the leg with the lock nut, element 3.4 at a distance=(Coupler height/2), [h/2].

FIG. 12 is an elevation of the leg with the intermediate assembly (III) at initial position.

FIG. 13 is an elevation of the leg with rotating couplers No. 4.3 to hit lock nut No. 3.4 at top & bottom.

FIG. 14 is an elevation of the leg with rotating lock nuts No. 4.2 to secure the couplers No. 4.3

FIG. 15 is an elevation of the leg with torquing top coupler No. 4.3 & secure it with lock nut No. 4.2

FIG. 16 is an assembly of three solid round sections with reinforcing Completed.

FIG. 17 is an enlarged isometric of the joint (from above).

FIG. 18 is an enlarged isometric of the joint (from below).

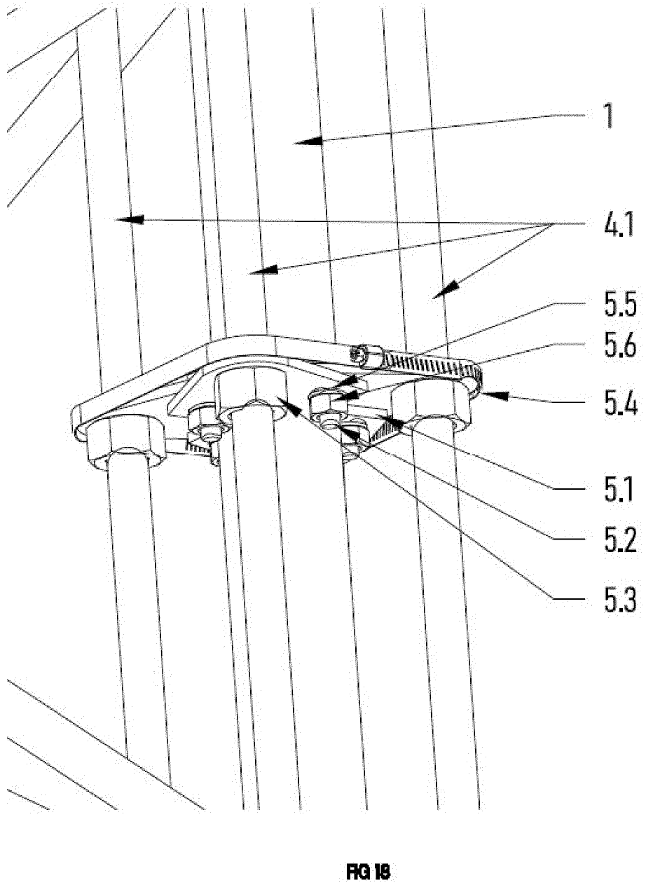

FIG. 19 are an isometric & 2D views of three sections with one set of reinforcing completed.

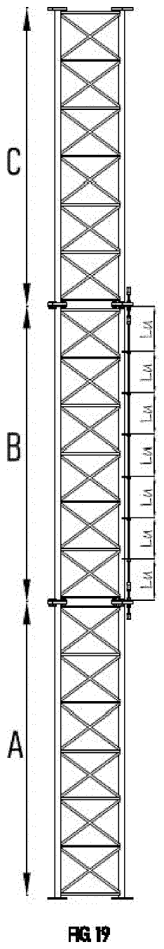

FIG. 20 is simulating solid round leg as a human without arms.

FIG. 21 is simulating solid round leg with reinforcing as a human with long arms.

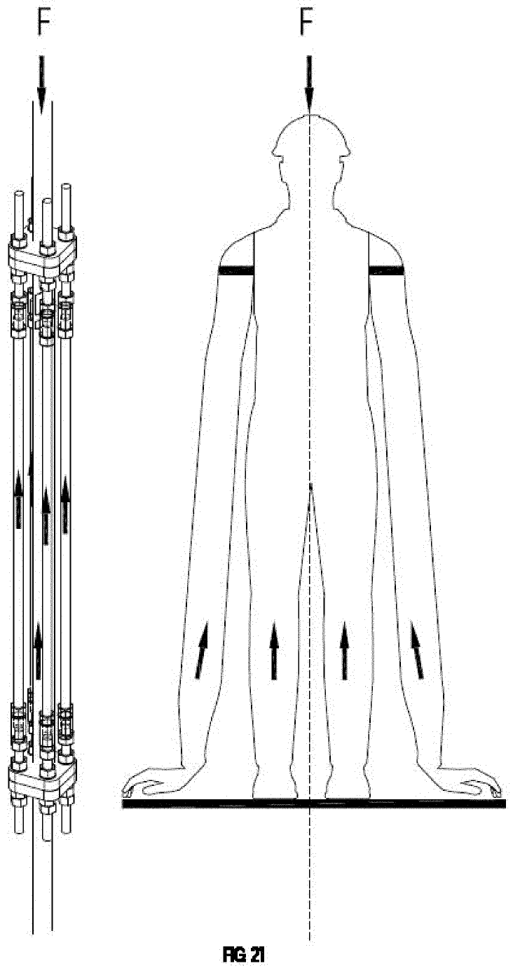

FIG. 22 is a chart of Compression Capacity of Solid round leg, f_{y}=43510 psi.

FIG. 23 is a chart of Compression Capacity of Solid round leg, f_{y}=50760 psi.

FIG. 24 is a chart of Compression Capacity of threaded bar, f_{y}=80060 psi.

FIG. 25 is a chart of Compression Capacity of threaded bar, f_{y}=89920 psi.

FIG. 26 is a chart of Compression Capacity of threaded bar, f_{y}=100080 psi.

### DETAILED DESCRIPTION

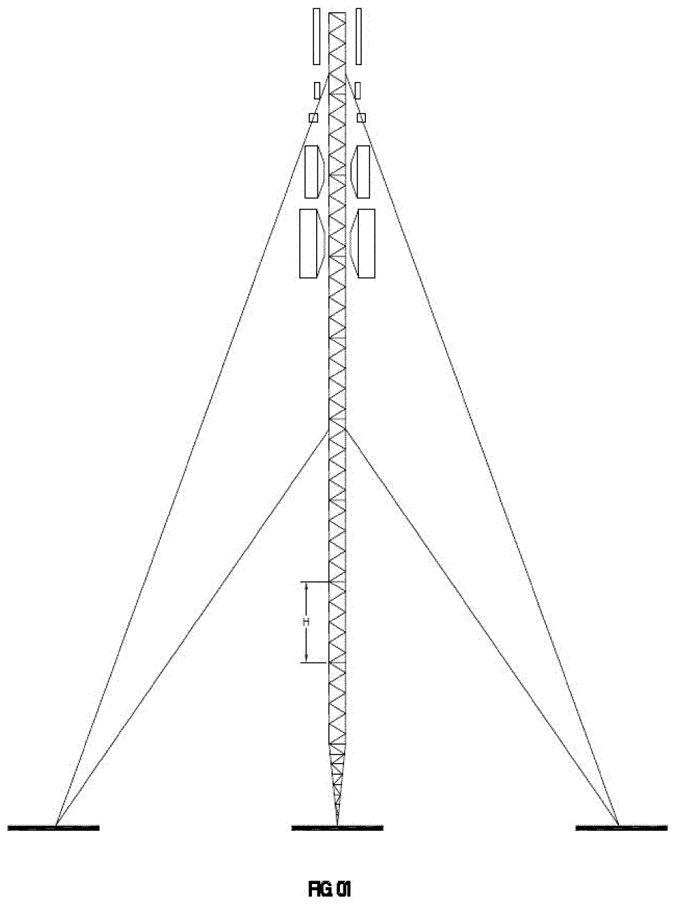

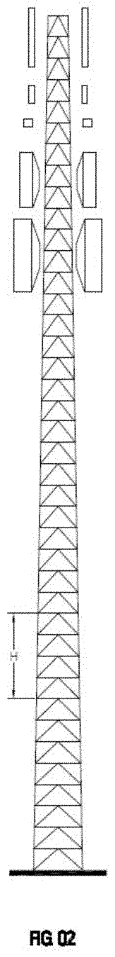

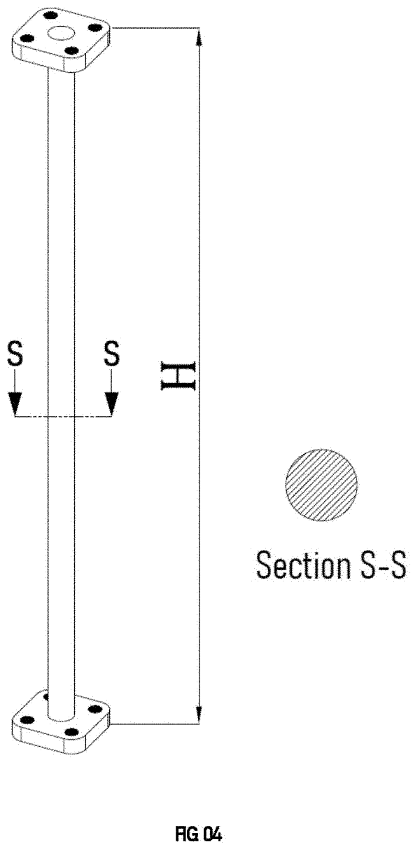

Telecom towers are two types, Guyed (FIG. 1) & Self-Support Tower (FIG. 2). Engineers use Solid Round(Circular) legs (FIG. 4) in both types because of its good sectional area properties being of a symmetrical shape and high torsional resistance. These towers are designed to support antennas, equipment and feeding cables and to resist wind pressure and ice. The telecom industry is growing so fast and requires changing antennas and their associated equipment frequently. These changes require structural engineers to check the structure to ensure the tower works within the allowable stress limits. In many cases some towers have issues with the legs. The main issue is being the compression resistance less than the compression load. The compression resistance is the compression value that the leg can resist safely, it is defined by leg cross sectional area, unsupported length and strength of material used. The compression load is the load going on leg due to dead load of structure (equipment, antennas, cables, mounts) and live load (wind & ice)

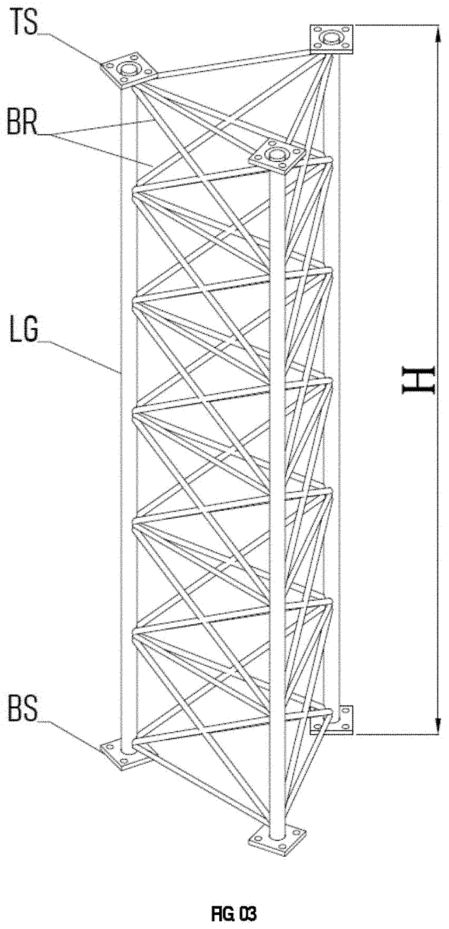

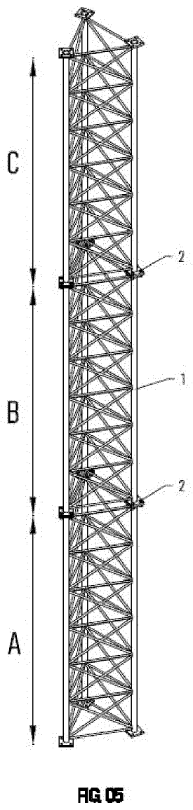

All weld guyed or all weld self-support towers consists of welded sections (FIG. 3). Each section is about (10 to 20) feet high (H)(FIGS. 1, 2, 3, 4 & 11). The three Legs (LG) are connected by bracing system, (diagonals & horizontals). Bracing pattern (BR) could be one of these common shapes X, W, S, IS or K system. Sections are connected through splice connections (splice pads and bolts). Splice pads are welded to the leg at top (TS) & bottom (BS). Bolts connect sections through its splice pads to form the tower assembly. Each tower is assembly of welded sections (FIG. 5).

By-law a structural engineer is required to analyze the tower structurally for any loading changes, dead load, or live load (Canadian Standard Association—S37), when the legs are getting highly stressed over the limit then reinforcing the leg is mandatory.

When the structural analysis identifies which section is overstressed then this method (invention) of reinforcing is required.

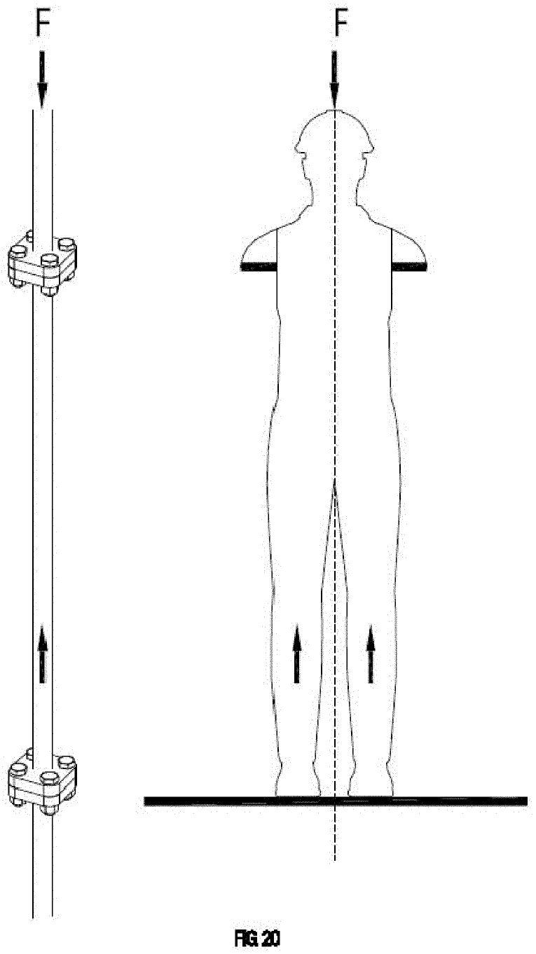

The idea behind this invention is demonstrated in (FIGS. 20 & 21). Solid round leg is simulated as a human without arms and loads reach the ground through the human legs. When the solid round leg is loaded with heavy load and it requires reinforcing, the threaded bars are simulated as adding arms to the human body and these arms are long and reaching the ground. Applying torque on couplers is like pushing the ground using hands to transfer part of the loading to the ground through the arms. By this way, heavy load is split between solid round leg and threaded bars.

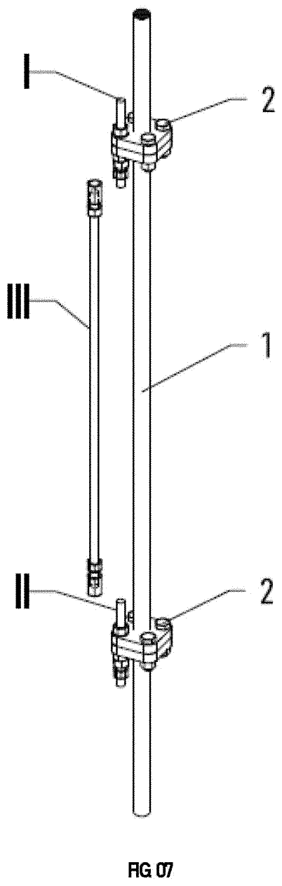

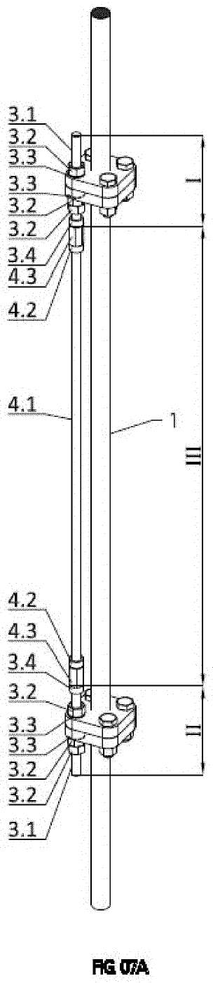

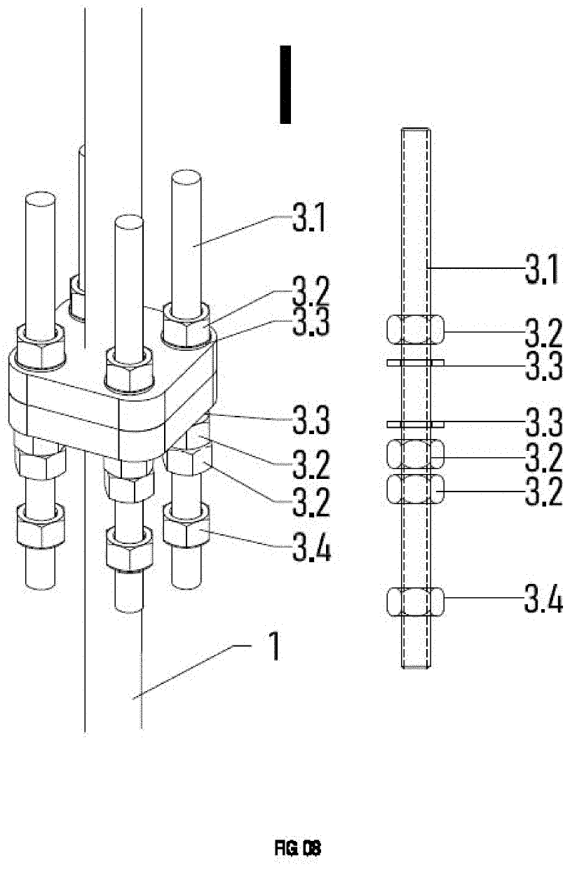

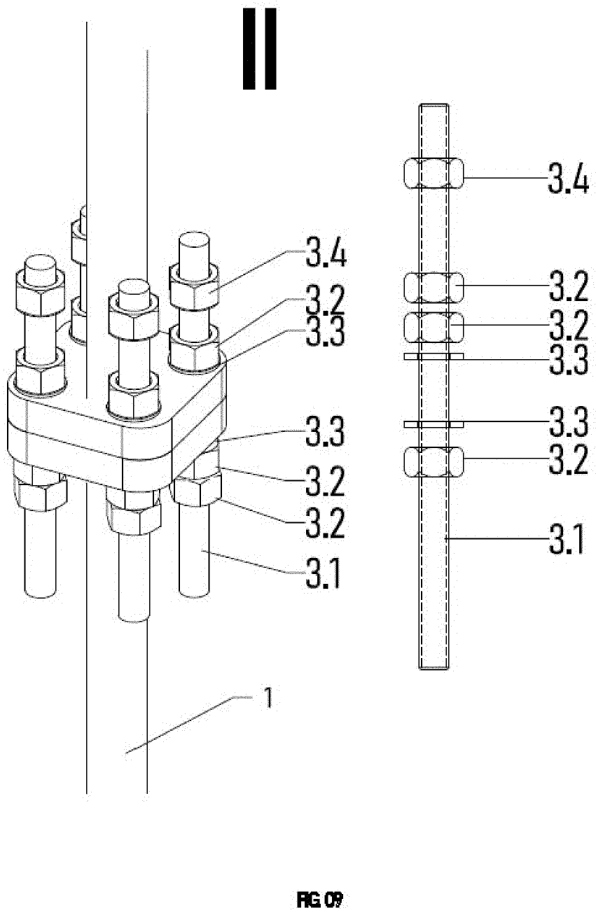

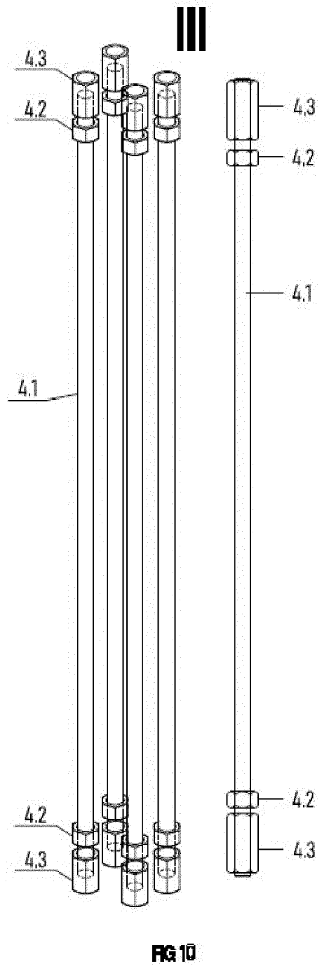

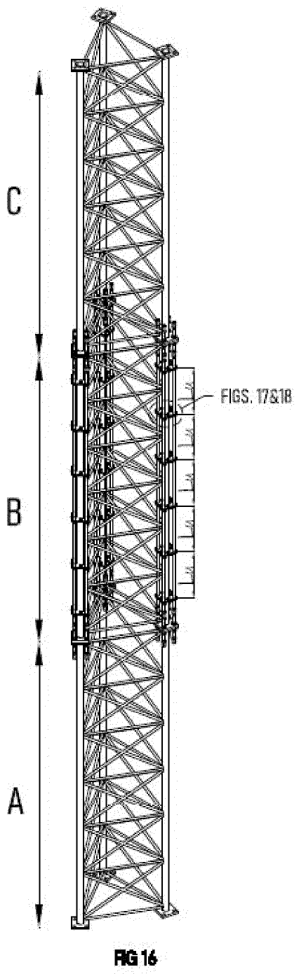

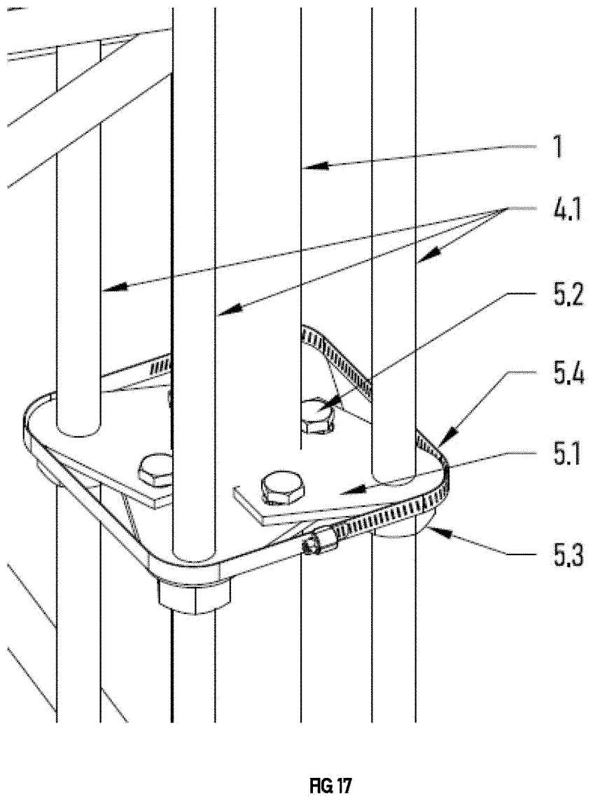

The assembly of this reinforcing method (invention) consists of three assemblies (I, II & III) (FIGS. 7 & 7A):
1. Assembly I consists of (FIG. 8):
   (1) Threaded bar No. 3.1
   (3) Nuts No. 3.2
   (2) Washers No. 3.3
   (1) Lock nut No. 3.4
2. Assembly II consists of (FIG. 9):
   (1) Threaded bar No. 3.1
   (3) Nuts No. 3.2
   (2) Washers No. 3.3
   (1) Lock nut No. 3.4
3. Assembly III consists of (FIGS. 10, 17 & 18):
   (1) Threaded bar No. 4.1
   (2) Lock nuts No. 4.2
   (2) Couplers No. 4.3
   (4)×n*, Plates No. 5.1
   (4)×n*, bolts No. 5.2
   (4)×n*, Nuts No. 5.3
   (1)×n*, Clamp No. 5.4
   (4)×n*, Washers No. 5.5
   (4)×n*, Nuts No. 5.6
n*=number of required joints to define the unsupported length (Lu) (FIG. 16).

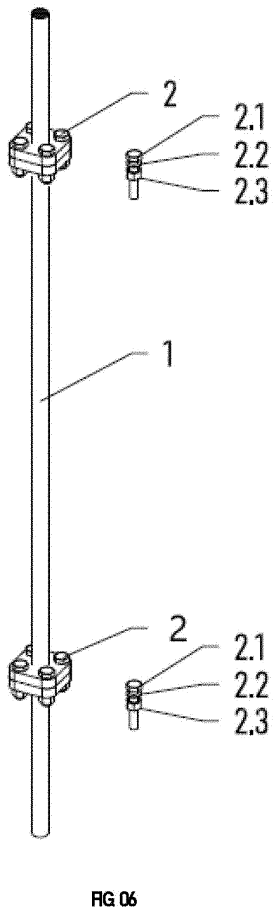

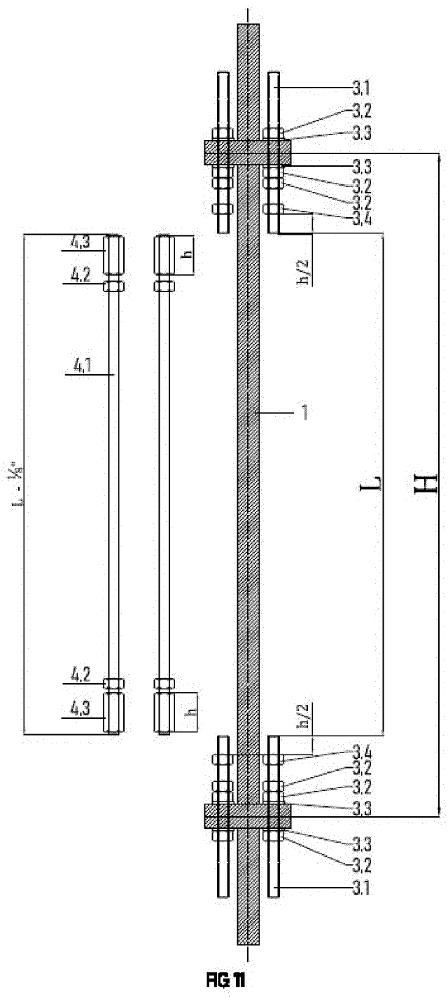

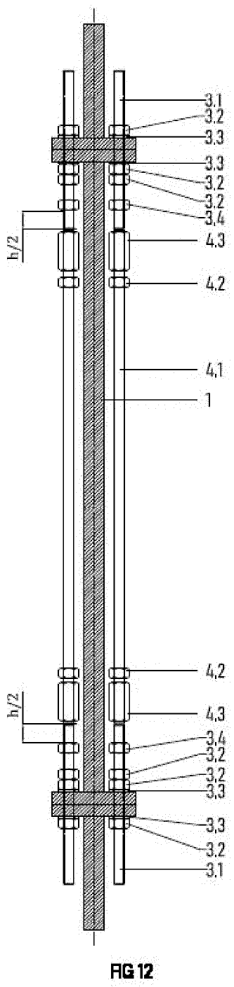

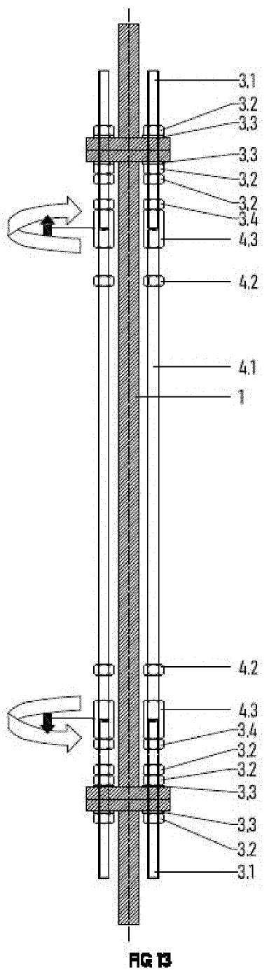

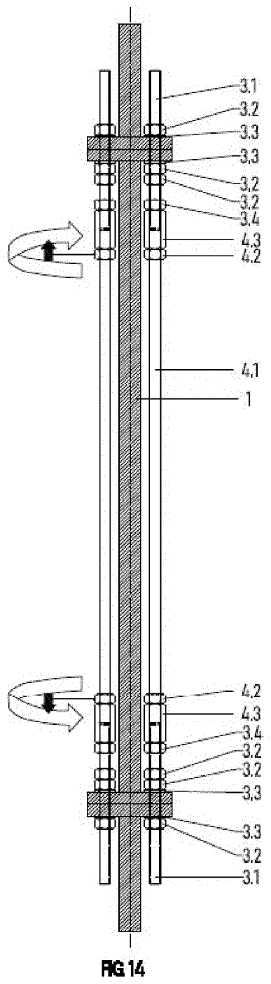

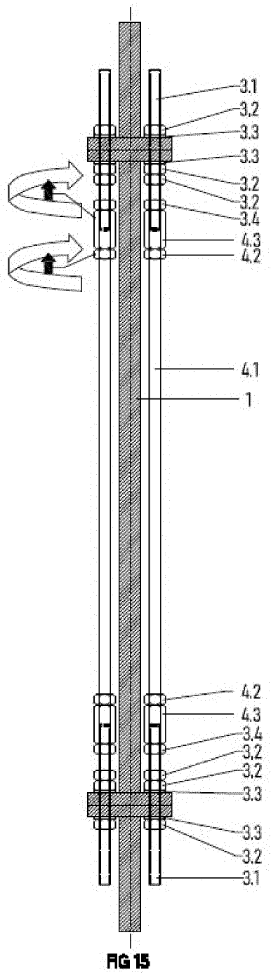

In the three sections assembly (FIG. 5), assuming mid-section (B) is overstressed, and it requires reinforcing. The procedure of this invention is as follows:
1. Replace splice bolts at top, bolting system 2 (FIG. 6), one at a time with the new threaded bar, assembly (I) (FIGS. 7 & 8).
2. Replace splice bolts at bottom, bolting system 2 (FIG. 6), one at a time with the new threaded bar, assembly (II) (FIGS. 7 & 9).
3. Repeat the previous steps to replace all the existing bolts (FIG. 6) with the new threaded bars, assembly I & II (FIGS. 8 & 9).
4. Prepare the intermediate assembly (III) (FIGS. 10 & 11), adding the number of plates No. 5.1 & nuts No. 5.3 (FIGS. 17 & 18) to have the required unsupported length (Lu) (FIG. 16) of the reinforcing system.
5. Adjust the lock nut No. 3.4 at top (FIG. 11) to be away from the end of threaded bar No. 3.1, assembly (I) by (coupler height)/2 [h/2].
6. Adjust the lock nut No. 3.4 at bottom (Ram to be away from the end of threaded bar No. 3.1, assembly (II) by (coupler height)/2 [h/2].
7. Place the intermediate assembly (III) in between top (I) & bottom (II) threaded bars (FIG. 12).
8. Rotate the coupler No. 4.3 at top, assembly (III) (FIG. 13) to hit the lock nut No. 3.4 in assembly (I).
9. Rotate the coupler No. 4.3 at bottom, assembly (III) (FIG. 13) to hit the lock nut No. 3.4 in assembly (II).
10. Repeat the previous steps for the rest of intermediate assembly (III) to have all threaded bars installed (FIG. 13).
11. Connect the plates No. 5.1, using bolts No. 5.2, washers No. 5.5 & nuts No. 5.6, in intermediate assembly (III) around the solid round leg (FIGS. 17 & 18).
12. Add the clamp No. 5.4 above the assembly of plates No. 5.1 in previous step and tighten it (FIGS. 17 & 18).
13. Tighten all the bolts No. 5.2 with nuts 5.6 connecting the plates No. 5.1 (FIGS. 17 &18).
14. Rotate the lock nut No. 4.2 in intermediate assembly (III) at top to secure the coupler No. 4.3 (FIG. 14).
15. Rotate the lock nut No. 4.2 in intermediate assembly (III) at bottom to secure the coupler No. 4.3 (FIG. 14).
16. Apply the required torque on top coupler No. 4.3 (FIG. 15), using wrench by rotating up towards the top splice and at the same time rotate the lock nut No. 4.2 (FIG. 15) to secure the coupler at final position.
17. By applying the required torque on all the intermediate threaded bars (III), one after another, an axial load has been created in the reinforcing mechanism and part of the load on the solid round leg has been transferred (FIG. 16).

### Definitions

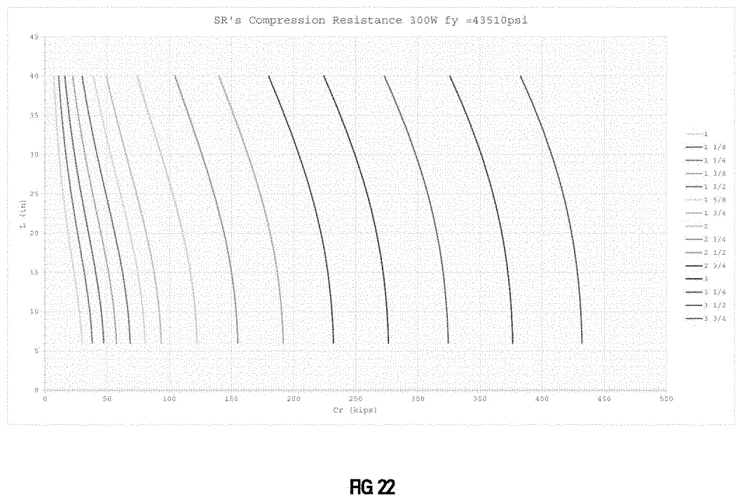

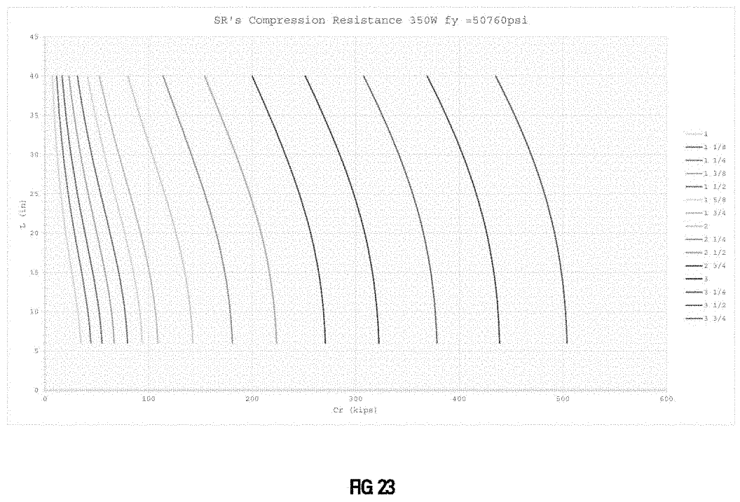

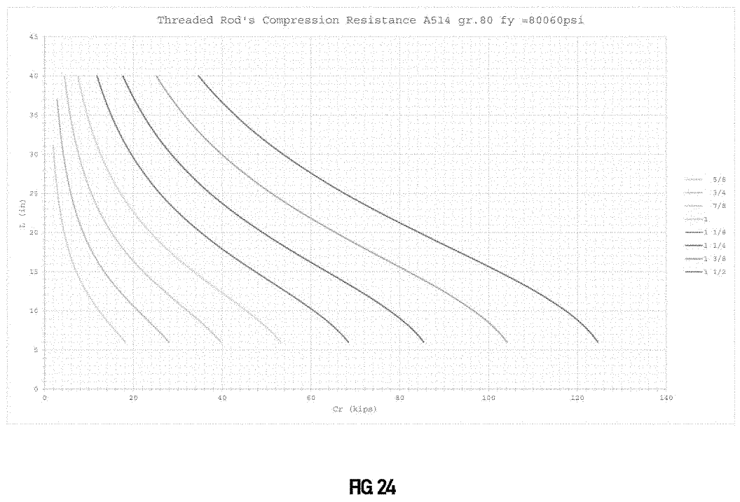

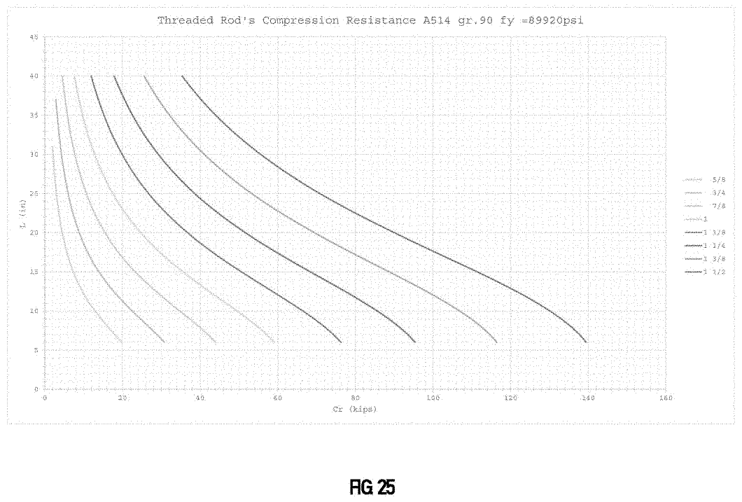

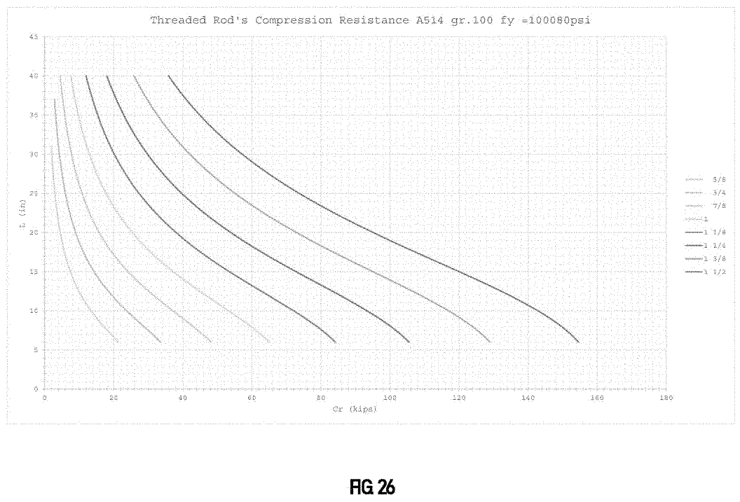

f_{y} Yield stress of steel (FIGS. 22,23, 24, 25, 26)
Lu Unsupported length, also called buckling length (FIGS. 16,19)
SR Solid Round (FIGS. 22, 23, 24, 25, 26)
LG Leg (FIG. 3)
TS Top splice (FIG. 3)
BS Bottom Splice (FIG. 3)
BR Bracing (FIG. 3)
H Height of solid round section 10 ft˜20 ft (FIGS. 1, 2, 3, 4, 11)
L =H−(length of element 3.1) (FIG. 11)
A 1st section in three sections assembly (FIG. 5)
B 2nd section in three sections assembly (FIG. 5)
C 3rd section in three sections assembly (FIG. 5)
I Top assembly (first assembly) (FIGS. 7, 7A, 8)
II Bottom assembly (second assembly) (FIGS. 7, 7A, 9)
III Intermediate assembly (third assembly) (FIGS. 7, 7A, 10)
1 Leg (FIGS. 5, 6, 7, 7A 8, 9, 11, 12, 13, 14, 15, 17, 18)
2 Existing bolting system assembly (FIGS. 5, 6, 7)
2.1 Existing Bolt (FIG. 6)
2.2 Existing washer (FIG. 6)
2.3 Existing Nut (FIG. 6)
3.1 Threaded bar (FIGS. 7A, 8, 9, 11, 12, 13, 14, 15)
3.2 Nut (FIGS. 7A, 8, 9, 11, 12, 13, 14, 15)
3.3 Washer (FIGS. 7A, 8, 9, 11, 12, 13, 14, 15)
3.4 Lock nut (FIGS. 7A, 8, 9, 11, 12, 13, 14, 15)
4.1 Threaded bar (FIGS. 7A, 10, 11, 12, 13, 14, 15)
4.2 Lock nut (FIGS. 7A, 10, 11, 12, 13, 14, 15)
4.3 Coupler (FIGS. 7A, 10, 11, 12, 13, 14, 15)
5.1 Plate (FIGS. 17,18)
5.2 Bolt (FIGS. 17,18)
5.3 Nut (FIGS. 17,18)
5.4 Clamp (FIGS. 17,18)
5.5 Washer (FIGS. 17,18)
5.6 Nut (FIGS. 17,18)

1. A method of reinforcing a solid round leg in existing telecom towers wherein reinforcing at least one load-bearing section of all existing lattice tower assembly, which load-bearing section has predetermined compression load, this method of reinforcing is a “MECHANISM” wherein can be installed for any number of overstressed sections, this method uses the top and bottom splices of the section of the tower assembly as a foundation and a platform to support this method of reinforcing, this said MECHANISM is installed at each leg of the section of the tower assembly, the vertical reinforcing elements of this said MECHANISM matches in number with the number of existing bolts per leg, each single reinforcing element of this said MECHANISM is replacing one single bolt at top and bottom of the section of the tower assembly, each reinforcing element of this method of reinforcing is comprising:
a. Assembly (I), at top splice, new bolting system, is comprising threaded bars with nuts and washers, this to replace the existing bolts with the same size & high strength, one at a time.
b. Assembly (II), at bottom splice, new bolting system is comprising threaded bars with nuts and washers, this to replace the existing bolts with the same size & high strength, one at a time.
c. Assembly (III), in between (I & II), is comprising threaded bars, lock nuts, plates, clamps, and couplers to connect with the threaded bars at top and bottom (I & II).

2. A method of reinforcing according to claim 1 wherein the length of assembly (III) is adjustable.

3. A method of reinforcing according to claim 2 further comprising one or more lateral support plates attached to the threaded bar (III) and forming a circle around the leg in center, wherein all plates are connected by bolts confining the leg of the section of the tower assembly in the center.

4. A method of reinforcing according to claim 3 further comprising one or more clamp holding all the lateral support plates with the tower leg of the section of the tower assembly in the center, the clamp is holding and squeezing all lateral support plates around the leg for tightening bolts to connect all lateral support plates together around the leg.

5. A method of reinforcing a solid round leg in existing telecom towers wherein reinforce one or more load-bearing sections of an existing lattice tower assembly, which load-bearing sections each have a predetermined compression load, which method comprises:
a. Assembling this said MECHANISM, start by replacing top & bottom existing bolts with the threaded bars (I & II), assembly (III) having an adjustable vertical measure which is less than the vertical measure between assembly (I & II).
b. Positioning assembly (III) in between assembly (I & II).
c. Positioning lateral support plates in claim 3, around tower leg of the section of the tower assembly.
d. Positioning the clamps on each level of the lateral support plates, tightening all bolts, connecting all the lateral support plates together around the leg.
e. lengthening assembly (III) such that for each vertical reinforcing element, the coupler in assembly (III) is rotated to vertically adjust the length of the said MECHANISM and transfer at least a portion of the compression load from the one or more load-bearing sections to said MECHANISM, so that the one or more load-bearing sections have a compression load that is lower than the predetermined compression load.
f. Lengthening continuing until a desired amount of load has been transferred to said MECHANISM.
